(19) United States
(12) Patent Application Publication
(10) Pub. No.: US 2014/0225734 A1
(43) Pub. Date: Aug. 14, 2014

(54) INHIBITING ALARMING OF AN ELECTRONIC ARTICLE SURVIELLANCE SYSTEM

(71) Applicants: Paul Brent RASBAND, Lantana, FL (US); Manjuprakash Rama RAO, Bangalore (IN); Surajit BORAH, Bangalore (IN); Sreenath K. RAMANNA, Bangalore (IN); Kevin LYNCH, Greenacres, FL (US); Nancy Lee VAN NEST, Delray Beach, FL (US); James A. COOK, Boynton Beach, FL (US); Jason PELSKI, Boca Raton, FL (US)

(72) Inventors: Paul Brent RASBAND, Lantana, FL (US); Manjuprakash Rama RAO, Bangalore (IN); Surajit BORAH, Bangalore (IN); Sreenath K. RAMANNA, Bangalore (IN); Kevin LYNCH, Greenacres, FL (US); Nancy Lee VAN NEST, Delray Beach, FL (US); James A. COOK, Boynton Beach, FL (US); Jason PELSKI, Boca Raton, FL (US)

(21) Appl. No.: 14/047,277

(22) Filed: Oct. 7, 2013

(30) Foreign Application Priority Data
Feb. 8, 2013 (IN) 377/DEL/2013

(51) Int. Cl. G08B 13/24

(52) U.S. Cl. CPC G08B 13/246
USPC 340/572.1

(57) ABSTRACT

An apparatus, system and method for inhibiting electronic article surveillance, EAS, system alarming are provided. A receiver is configured to receive captured identification data after a transaction. A processor is configured to determine whether the captured identification data is associated with the transaction. The processor is further configured to determine whether to inhibit EAS system alarming based at least in part on the determination whether the captured identification data is associated with the transaction. The determination whether to inhibit EAS system alarming is made without regard to whether an active EAS tag is detected. A transmitter configured to transmit an authorization message. The authorization message indicates whether to inhibit EAS system alarming.

### STATEMENT REGARDING FEDERALLY SPONSORED RESEARCH OR DEVELOPMENT

n/a

### FIELD OF THE INVENTION

The present invention relates to security systems, and in particular to electronic article surveillance, EAS, system alarming.

### BACKGROUND OF THE INVENTION

Businesses are constantly seeking ways to maximize customer satisfaction while at the same time improving sale finalization, i.e., completing a transaction. Waiting in line for ten to fifteen minutes to purchase items is one of the causes of customer dissatisfaction that may result in a customer abandoning their items, thereby hindering sale finalization. While some customers may re-visit the store during a less crowded period to purchase the abandoned items, others customers may not, thereby reducing the retail store's profits. Moreover, even if a customer chooses to re-visit the store to purchase abandoned items, it is possible that the abandoned items will be purchased by another customer before the re-visit, thereby reducing customer satisfaction. General frustration with long lines at store checkout stands can also harm a retailer's brand and keep new customers from visiting the store.

In order to help minimize issues associated with long wait times and poor sales finalization, some businesses have implemented mobile point of sale, POS, terminals to replace, or to be used in conjunction with, fixed POS terminals. Mobile POS terminals consist of an employee with a mobile device such as a tablet or other small handheld computer that can finalize a sale by allowing a customer to pay for items. Mobile POS terminals allow every employee equipped with the mobile device to have the capability to finalize a sale, such that more sales may be finalized without customers having to endure long wait times.

However, mobile POS terminals are not without faults. For example, some items may have an associated security tag that, when active and within a tag interrogation zone, triggers an alarm. The mobile POS terminal needs to have a dedicated tag deactivator or needs to be located near a tag deactivator in order to be able to disable the security tag. However, requiring a mobile POS terminal to be near a tag deactivator, limits mobility of the mobile POS terminal. Also, while mobile POS terminals may be constructed with a specific type of tag deactivator, e.g., acousto-magnetic tag deactivator, including the deactivator increases the upfront cost associated with mobile POS terminals and cost of upgrading equipment. Also, because tag deactivation is a relatively power intensive process, the use of a tag deactivator attached to and deriving its power from the battery of the mobile POS terminal may greatly increase the frequency with which the mobile POS terminal's battery must be charged. This reduces the convenience and workability of the mobile POS process, from the retail employee's perspective.

### SUMMARY OF THE INVENTION

The present invention advantageously provides a method, system and apparatus for an electronic article surveillance, EAS, system.

According to one embodiment, an apparatus for inhibiting electronic article surveillance, EAS, system alarming is provided. The apparatus includes a receiver configured to receive captured identification data after a transaction. The apparatus further includes a processor configured to determine whether the captured identification data is associated with the transaction. The processor is further configured to determine whether to inhibit EAS system alarming based at least in part on the determination of whether the captured identification data is associated with the transaction. The determination whether to inhibit EAS system alarming is irrespective whether an active EAS tag is detected. The apparatus further includes a transmitter configured to transmit an authorization message. The authorization message indicates whether to inhibit EAS system alarming.

According to another embodiment, a system for inhibiting electronic article surveillance, EAS, alarming is provided. The system includes an identification device. The identification device includes a capture element configured to capture identification data after a transaction. The system further includes an apparatus in communication with the identification device. The apparatus includes a processor configured to determine whether to inhibit EAS alarming based at least in part on whether the captured identification data is associated with the transaction. The determination of whether to inhibit EAS alarming is irrespective whether an active EAS tag is detected. The apparatus further includes a transmitter configured to transmit an authorization message. The authorization message indicates whether to inhibit EAS alarming.

According to another embodiment, a method for inhibiting electronic article surveillance, EAS, system alarming is provided. Identification data captured after a transaction received. A determination whether the captured identification data is associated with the transaction is made. A determination whether to inhibit EAS system alarming is made based at least in part on the determination whether the captured identification data is associated with the transaction. The determination whether to inhibit EAS system alarming is irrespective whether an active EAS tag is detected.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a view of an exemplary electronic article surveillance, EAS, system constructed in accordance with the principles of the present invention;

FIG. 2 is a block diagram of the exemplary EAS system of FIG. 1 constructed in accordance with the principles of the present invention;

FIG. 3 is a flow chart of an exemplary indication process according to the principles of the present invention;

FIG. 4 is a flow chart of an exemplary verification process according to the principles of the present invention;

FIG. 5 is a flow chart of an exemplary video analytics process according to the principles of the present invention;

FIG. 6 is a flow chart of an exemplary monitoring process according to the principles of the present invention;

FIG. 7 is a flow chart of an exemplary EAS alarming inhibit process according to the principles of the present invention; and

FIG. 8 is a flow chart of an exemplary deactivation code process according to the principles of the present invention.

### DETAILED DESCRIPTION OF THE INVENTION

The present invention advantageously provides a system, apparatus and method for electronic article surveillance, EAS, systems. Accordingly, the system, apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

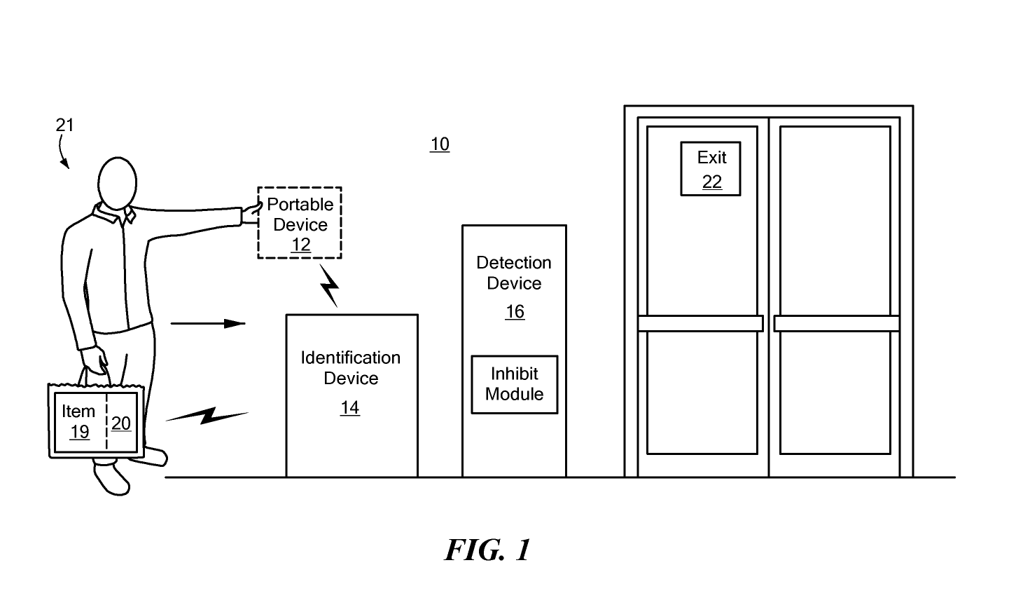

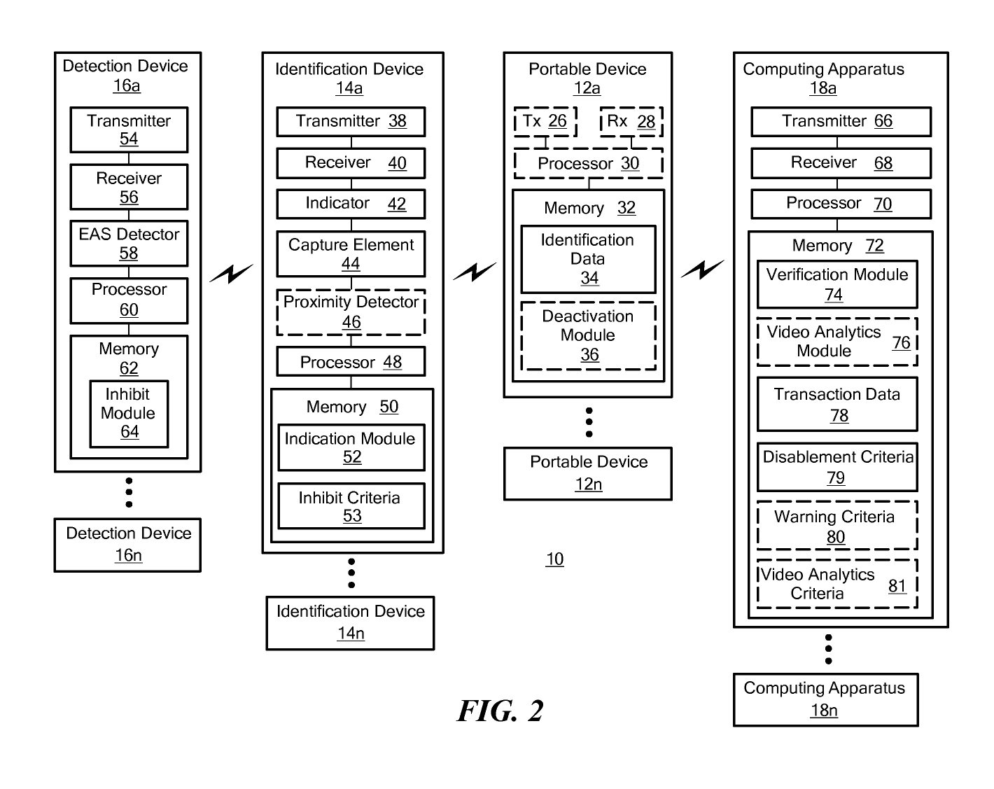

Referring to the drawing figures in which like reference designators refer to like elements there is shown in FIG. 1 a view of an electronic article surveillance (“EAS”) system 10 constructed in accordance with the principles of the present invention and designated generally as “10.” System 10 includes portable device 12, identification device 14, detection device 16 and computing apparatus 18 (FIG. 2), in which consumer 21 has one or more items 19 (collectively referred to as “item 19”) associated with one or more tags 20 (collectively referred to as “tag 20”) is walking towards exit 22. Computing apparatus 18 can be a desktop computer, standalone server or blade server such as a local or remote “cloud” server, or any computing device capable of performing the functions described herein. Portable device 12 is configured to communicate identification data with identification device 14. Portable device 12 may be a smart phone, near field communication (“NFC”) enabled mobile phone, credit card, store membership card, radio frequency identification (“RFID”) transponder based identification card or receipt, key fob or other personal identification device capable of communicating identification data via a data transmission interface, e.g., near field communication (NFC) or RFID wireless backscatter, optical character recognition of printed letters or numbers, barcode scanning, etc., to identification device 14.

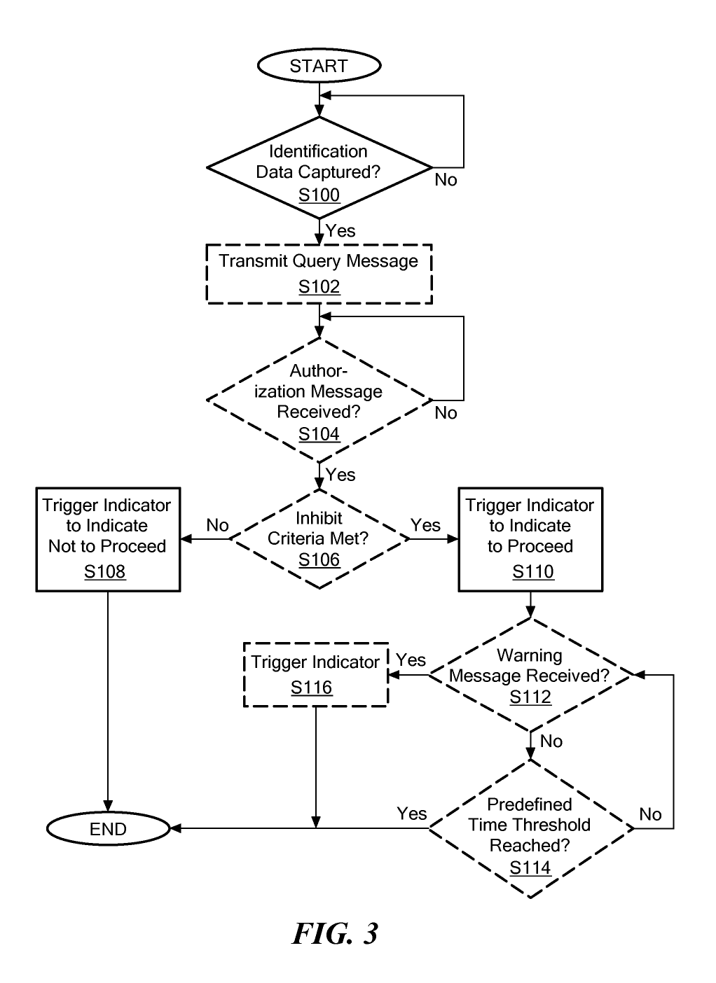

Identification device 14 is configured to communicate identification data and/or trigger indicator 42 (FIG. 2). In one embodiment, after consumer 21 has purchased item 19 at a mobile or fixed point of sale (“POS”) terminal, consumer 21 swipes or “bumps” portable device 12 with identification device 14 such that identification data is communicated to identification device 14, as discussed in detail with respect to FIG. 3. In one embodiment, the identification data is captured after a completed transaction. In another embodiment, identification element 14 captures an identifier from the RFID portion of a tag 20 after a completed transaction, i.e., tag 20 is a combination RFID/EAS tag, as discussed in detail with respect to FIG. 3. Consumer 21 receives an indication from identification device 14 whether consumer has been granted permission to exit, as discussed in detail with respect to FIG. 3. Receiving an exit indication prompts consumer 21 to proceed to exit 22 while gating or inhibiting an EAS alarm when active tag 20, in consumer's shopping bag, is detected.

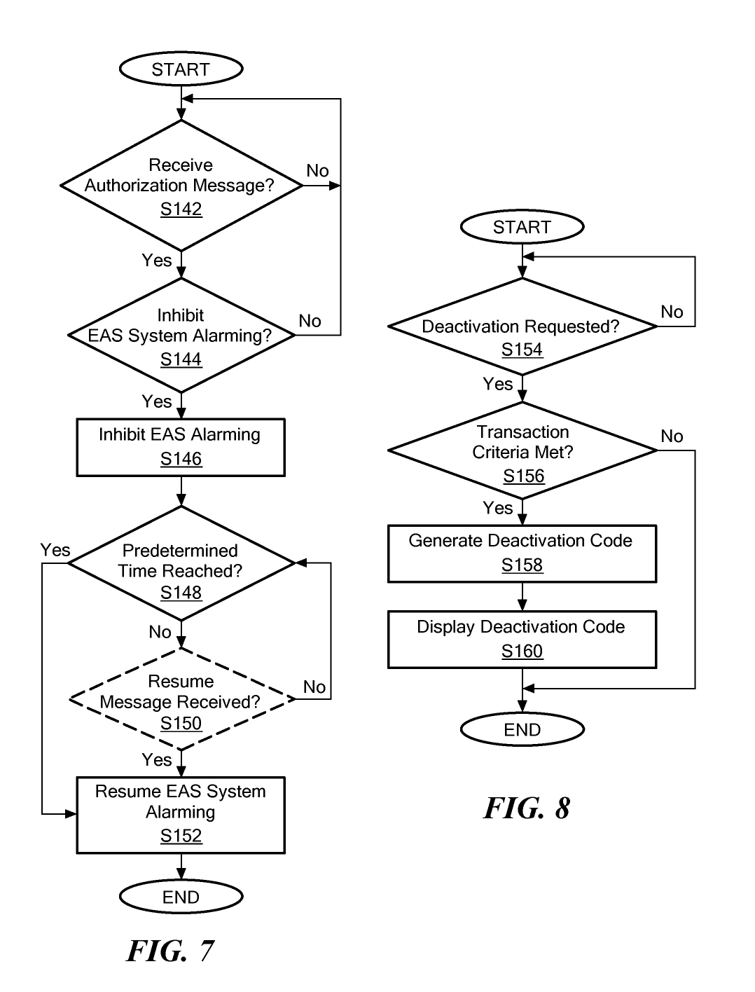

Detection device 16 is configured to trigger an alarm when an active EAS tag is detected within an interrogation zone produced by detection device 16. Detection device 16 is further configured to inhibit EAS alarming as discussed in detail with respect to FIG. 7. Tag 20 is a security tag that is detectable by detection device 16 when tag 20 is active. Tag 20 may include one or more types of electronic article surveillance, EAS, tags such as acousto-magnetic (“AM”) tag, radio frequency identification (“RFID”) tag or dual RFID/EAS tag, among other EAS tags known in the art. Such tags may or may not have been deactivated at the POS or in some other part or process in the store, and it is the function, as described below, for an active EAS tag to cause an alarm when brought into the proximity of detection device 16 when detection device 16 is active. In other words, an active EAS tag and active detection device 16, together, result in an alarm condition.

With reference to FIG. 2, there is illustrated a block diagram of the system 10 of FIG. 1. One or more portable devices 12a to 12 n (collectively referred to as “portable device 12”) include one or more transmitters 26 and one or more receivers 28 configured to communicate with identification device 14 and/or computing apparatus 18. Portable device 12 also includes memory 32 and processor 30 in communication with transmitter 26, receiver 28 and memory 32 in which processor 30 performs portable device 12 functions. Processor 30 may be one or more central processing units (CPUs) for executing computer program instructions stored in memory 32, as is well known in the art.

Memory 32 includes non-volatile and volatile memory. For example, non-volatile memory may include a hard drive, flash memory, memory stick and the like. Also, volatile memory may include random access memory and others known in the art. Memory 32 may store identification data 34 associated with one or more consumers, e.g., consumer 21. Memory 32 may also store program instructions, which when executed by processor 30, provide the functionality described herein for deactivation module 36. For example, deactivation module 36 includes instructions, which when executed by processor 30, cause processor 30 to perform the deactivation code process, discussed in detail below with reference to FIG. 8. In an alternative embodiment, portable device 12 may only include memory 32 storing identification data, i.e., may be a credit card or membership card. Alternatively, portable device 12 may be omitted from system 10 such that identification device 14 receives identification data 34 from the RFID portion of combination RFID/EAS tag 24.

System 10 includes one or more identification devices 14a to 14n (collectively referred to as “identification device 14”). Identification device 14 includes one or more transmitters 38 and one or more receivers 40 configured to communicate with portable device 12, detection device 16 and/or computing apparatus 18. Identification device 14 also includes indicator 42 that is configured to indicate to consumer 21 whether to proceed through an EAS interrogation zone, i.e., indicates whether EAS system alarming has been inhibited. For example, indicator 42 may be one or more light emitting diodes (“LEDs”), audio/video display, audible indicator, combination audio/visual indicator and/or haptic indicator, among other indicators capable of indicating to consumer 21 whether to proceed to exit 22. Identification device 14 also includes capture element 44 that is configured to capture identification data 34 after a completed transaction, e.g., captures identification data 34 as a consumer is walking towards exit 22 after making a purchase. Capture element 44 may be an NFC reader, RFID reader and/or card reader, among other readers configured to receive identification data 34 such as a customer identifier, mobile phone identifier, account number and membership number, among other identifier codes that may be read by capture element 44. In another example, identification data 34 may be an RFID identifier associated with the RFID portion of a combination RFID/EAS tag.

Alternatively, capture device 44 may be a biometric scanner configured to capture identification data from a user's fingerprint or other human characteristic(s) that is measurable by biometric reader that may be used to identify a human. Identification device 14 may include proximity detector 46 configured to detect the presence of consumer 21. Proximity detector 46 may be an infrared detector, among other types of detectors capable of detecting the presence of a human or object within a predefined zone. Identification device 14 also includes processor 48 and memory 50 that generally correspond to components of portable device 12, with size and performance being adjusted based on design need, while providing the functionality described herein with respect to identification device 14. Memory 50 includes indication module 52 that is configured to trigger an indication whether consumer 21 is authorized to enter an EAS interrogation zone produced by detection device 16, i.e., indicates whether consumer 21 is allowed to exit via exit 22. For example, indication module 52 includes program instructions, which when executed by processor 48, cause processor 48 to perform the indication process, discussed in detail below with respect to FIG. 3. Memory 50 may also store inhibit criteria 53 that is also discussed in detail with respect to FIG. 3.

Detection device 16 may include transmitter 54, receiver 56, processor 60 and memory 62 in communication with each other. In particular, transmitter 54, receiver 56, processor 60 and memory 62 generally correspond to the components of identification device 14 and/or portable device 12, with size and performance being adjusted based on design needs, while providing the functionality described herein with respect to detection device 16. For example, transmitter 54 and receiver 56 are configured to communicate with identification device 14, portable device 12 and/or computing apparatus 18 using communication protocols known in the art. Detection device 16 also includes EAS detector 58 that is configured to establish an EAS interrogation zone for detecting active EAS tags located within the EAS interrogation zone. EAS detector 58 may be an acousto-magnetic tag detector, among other types of detectors known in the art that detect an EAS portion of tag 24. Memory 62 includes inhibit module 64 that is configured to inhibit EAS alarm signaling. For example, inhibit module 64 includes program instructions, which when executed by processor 60, cause processor 60 to perform the inhibit process, discussed in detail with respect to FIG. 7.

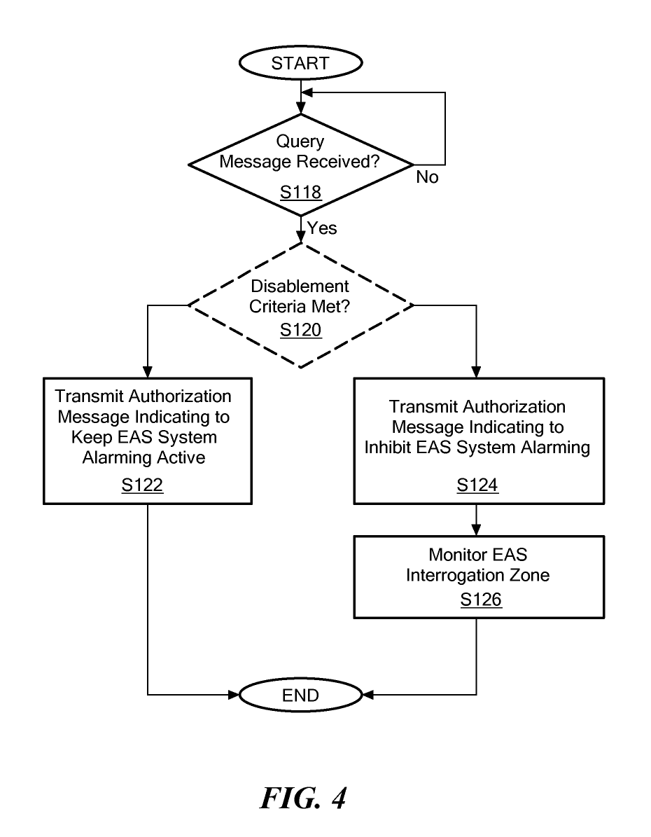

Computing apparatus 18 includes transmitter 66, receiver 68, processor 70 and memory 72 in communication with each other. Transmitter 66, receiver 68, processor 70 and memory 72 generally correspond to the components of portable device 12, identification device 14 and/or detection device 16, with size and performance being adjusted based on design needs, while providing the functionality described herein with respect to computing apparatus 18. Transmitter 66 and receiver 68 are configured to communicate information with portable device 12, identification device 14 and/or detection device 16 using one or more communication protocols known in the art. Memory 72 includes verification module 74, video analytics module 76, transaction data 78, disablement criteria 79, warning criteria 80 and video analytics criteria 81. In particular, verification module 74 includes program instructions, which when executed by processor 70, cause processor 70 to perform the verification process, discussed in detail with respect to FIG. 4.

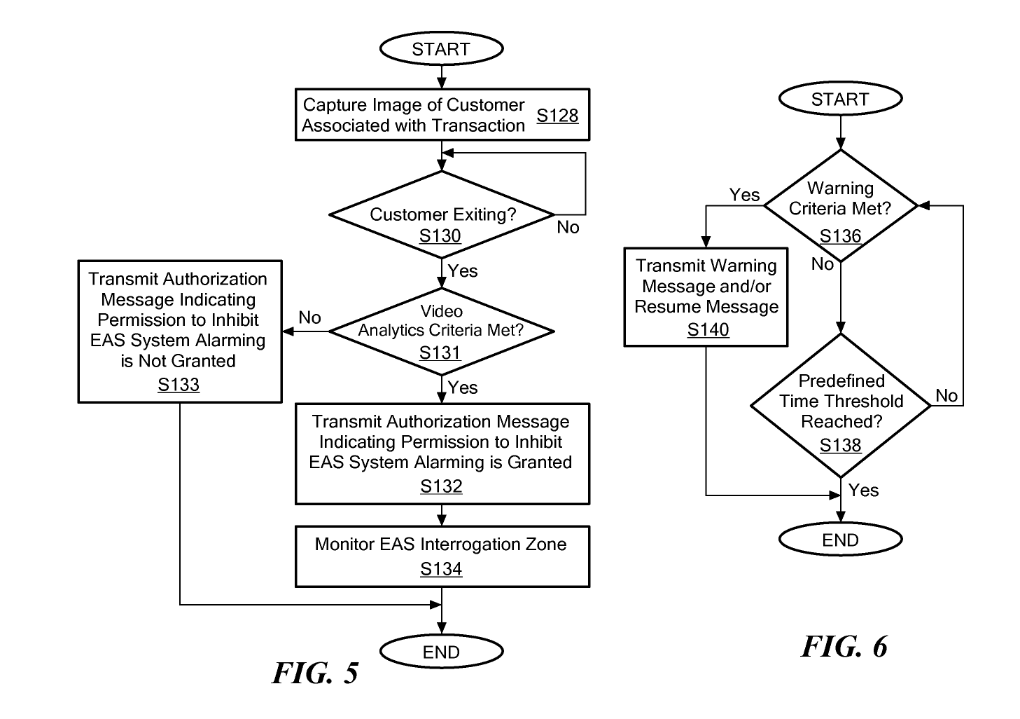

Video analytics module 76 includes program instructions, which when executed by processor 70, cause processor 70 to perform the video analytics process, discussed in detail with respect to FIG. 5. Transaction data 78 includes information associated with one or more transactions by customer 21 such as sold item identifier(s), time transaction was finalized and customer identifier, among other information associated with transaction. Transaction data 78 may be stored in memory 72 for a predetermined amount of time, e.g., thirty minutes, before being erased or purged from memory 72. In other words, transaction data 78 remains available for use by verification module 74 for the predetermined amount of time. Alternatively, memory 72 may store transaction data 78 until erased by an authorized user such as a store manager or system administrator.

An exemplary indication process is described with reference to the flow chart of FIG. 3. Processor 48 determines whether identification data 34 associated with a completed transaction or purchase has been captured from identification device (Block S100). In one example, processor 48 determines whether capture element 44 has captured identification data 34. For example, processor 48 may determine that identification data has been captured from consumer 21's mobile phone, i.e., portable device 12, via an NFC “bump” when consumer 21 is walking toward exit 22 after a purchase. In another example, capture element 44 is an RFID reader that captures identification data 34 from the RFID portion of a combination RFID/EAS tag 24 within the read zone of the RFID reader such as when consumer 21 walking toward exit 22 after completing a transaction. The read zone may be larger than the EAS interrogation zone when the RFID reader is collocated with EAS detector 58 such that the RFID portion of tag is detected before the EAS portion of tag 24. Alternatively, the read zone may be equal to or smaller than the EAS interrogation zone when the RFID reader is located further from exit 22 than EAS detector 58 such that customer 21 enters the read zone before the EAS interrogation zone. In another alternative, the read zone and EAS interrogation zone may be substantially the same but EAS alarming may be delayed to allow system 10 to determine whether to inhibit EAS alarm signaling before triggering an audio and/or visual EAS alarm. In other words, captured identification data 34 is captured after a transaction has been completed.

If the determination is made identification data 34 has not been captured, Block S100 may be repeated. If the determination is made identification data 34 has been captured, processor 48 causes transmitter 38 to transmit a query message to computing apparatus 18 (Block S102). The query message indicates a request to inhibit EAS system alarming is being made. The query message includes captured identification data 34.

Processor 48 determines whether an authorization message has been received (Block S104). For example, processor 48 determines whether an authorization message has been received from computing apparatus 18 in response to the transmitted query message. If the determination is made an authorization message has not been received, the determination of Block S104 is repeated. Alternatively, processor 48 may cause indicator 42 to prompt customer 21 to reinitiate the capture of identification data 34 in which processor 48 performs the determination of Block S100, e.g., indicator 42 may be a video display that prompts customer to re-bump portable device 12 to identification device 14.

If the determination is made an authorization message has been received, processor 48 determines whether an inhibit criteria 53 are met (Block S106). In particular, the inhibit criteria 53 defines one or more rules that need to be met in order to trigger indicator 42 to indicate to consumer 21 to exit via exit 22. In one example, the inhibit criteria 53 are met when the received authorization message indicates authorization to inhibit EAS alarm signaling is granted. The inhibit criteria 53 are not met when the authorization message indicates authorization to inhibit EAS system alarming is not granted. Alternatively, inhibit criteria 53 are not met when an authorization message is not received within a predefined time period after capturing identification data 34. In another example, inhibit criteria 53 are met when the received authorization message indicates authorization to inhibit EAS alarm signaling and proximity data from proximity detector 46 indicates no other consumers 21 are present within a predefined zone, i.e., proximity detector 46 may be arranged to detect consumers within the interrogation zone or a zone proximate identification device 14.

In one example, inhibit criteria 53 are not met when the received authorization message indicates authorization to inhibit EAS alarm signaling but proximity data from proximity detector 46 indicates consumer 21 is no longer proximate identification device 14 and a second consumer 21 is detected proximate identification device 14. In other words, consumer 21 “bumped” identification device 14 with portable device 12 and kept walking without waiting for indicator 42 to trigger, during which another consumer 21 was detected moving towards exit 22, i.e., second consumer 21 or thief “tailgates” first consumer 21 who had a legitimate purchase hoping EAS system alarming will be inhibited while both first and second consumers walk pass detection device 16 to exit 22. In another example, inhibit criteria 53 may be met when identification data 34 includes a deactivation code such that Blocks S102 and S104 may be skipped, i.e., the received code from portable device 12 matches a predetermined deactivation code stored in memory 50. Inhibit criteria 53 may include other rules for determining whether to trigger indicator 42.

If processor 48 determines inhibit criteria 53 not met, processor 48 causes indicator 42 to trigger an indication not to proceed toward exit 22 (Block S108). If the determination is made that inhibit criteria 53 are met, processor 48 causes indicator 42 to trigger an indication that consumer 21 may proceed to exit 22 (Block S110). After the indication to proceed to exit 22 is triggered, processor 48 may determine whether a warning message has been received (Block S112). The warning message indicates suspicious activity within the EAS interrogation zone after EAS system alarming has been inhibited. For example, the warning message may indicate another consumer 21 is detected in the predefined zone while EAS alarming is inhibited. If the determination is made a warning message is received, indicator 42 is triggered (Block S116). For example, the indicator may warn the other detected consumer to wait or return back to a non-detection zone. In another example, warning message may alert an employee to monitor the predefined zone such as the EAS interrogation zone.

If the determination is made that a warning message has not been received, processor 48 determines whether a predefined time threshold has been reached (Block S114). The predefined time threshold corresponds to an amount of time EAS system alarm signaling is inhibited. In other words, processor 48 monitors for receipt of warning message while EAS system alarm signaling is inhibited. If processor 48 determines the predefined time threshold has not been reached, processor 48 performs the determination of Block S112 again. However, if the determination is made the predefined time threshold has been reached, i.e., EAS system alarm signal is not longer inhibited, the indication process may end or return to Block S100. In an alternative embodiment, Block S112-S116 may be omitted based on design need.

An exemplary verification process is described with reference to FIG. 4. Processor 70 in computing apparatus 18 determines whether a query message has been received (Block S118). For example, processor 70 determines whether the query message generated by identification device 14 has been received. If the determination is made a query message has not been received, processor 70 repeats the determination of Block S118. If processor 70 determines a query message has been received, processor 70 determines whether disablement criteria 79 are met (Block S120). The disablement criteria 79 include one or more rules that must be met in order to initiate disablement of EAS system alarming. For example, one rule in the disablement criteria 79 may include disabling EAS system alarming when received identification data is associated with a transaction, i.e., processor 70 determines the received identification data is associated with transaction data 78 or associated with a completed transaction. In particular, computing apparatus 18 may store transaction data 78 for one or more transactions in memory 72 for a predefined amount of time after each respective transaction. After the predefined amount of time, the respective transaction may be deleted from memory 78 such that processor 70 will determine the received identification data is not associated with transaction data 78 if the query message is received after deletion of associated transaction data 78. In other words, a consumer has a predefined amount of time to exit the store without triggering EAS system alarming in system 10 after purchasing items having active EAS tags.

Another rule in the disablement criteria 79 may include disabling EAS system alarming when received identification data in the query message is associated with transaction data 78 and proximity data received in query message indicates no other people are proximate the predefined zone. Another rule may be based on the number of times identification data 34 has been captured by detection device 14. For example, EAS system alarming will not be disabled or inhibited if the RFID identifier has been capture more than a predetermined number of times. Another rule may include disabling EAS system alarming is the received code, i.e., identification data 34, matches a code stored in memory 50. Also, disablement criteria 79 may include one or more rules from warning criteria 80 and/or video analytics criteria 81 discussed below. For example, disablement criteria 79 may include a rule for determining whether the customer or user associated with the transaction interacted with merchandise, i.e., un-purchased items, along the path trace of the customer in which the path trace is from a transaction location to a predetermined location different from the transaction location such as the location of identification device 14. The path trace may be generated by video analysis and/or wireless sensor network as discussed below.

If the determination is made that the disablement criteria 79 is not met, processor 70 causes transmitter 66 to transmit an authorization message indicating permission to inhibit EAS system alarming is not granted, i.e., EAS system alarming is kept active (Block S122). For example, transmitter 66 may transmit the authorization message to identification device such that indicator 42 is triggered, as discussed above with respect to Blocks S108 and S110. Alternatively, processor 70 does not transmit an authorization message if the disablement criteria are not met such that detection device 16 will remain active, i.e., detection device 16 keeps EAS interrogation zone active if an authorization message is not received. One or more authorization messages indicating EAS system alarming remains active may be transmitted to identification device 14, portable device 12 and/or detection device 16 using one or more communication protocols.

If processor 70 determines disablement criteria 79 is met, processor 70 cause transmitter 66 to transmit an authorization message indicating permission to inhibit EAS system alarming is granted (Block S124). For example, detection device 16 inhibits EAS system alarming when a received authorization message indicates to inhibit the alarming, as discussed in detail with respect to FIG. 6. In other words, the determination whether to inhibit EAS system alarming is made without regard to whether an active EAS tag is detected as disablement criteria 79 does not rely on active EAS tag detection.

One or more authorization messages indicating to inhibit EAS system alarming may be transmitted to detection device 16, identification device 14 and/or portable device 12 using one or more communication protocols. Also, identification device 14 and/or portable device 12 may indicate to consumer 21 to proceed to exit 22 when the authorization message indicates permission to inhibit EAS system alarming is granted. Processor 70 monitors the EAS interrogation zone for suspicious activity as discussed in detail with respect to FIG. 6 (Block S126). Alternatively, Block S126 may be skipped based on design need.

FIG. 5 illustrates an exemplary video analytics process used to determine whether to inhibit EAS system alarming. Processor 70 causes one or more images of a customer associated with a transaction to be captured, i.e., identification data is the captured image (Block S128). For example, the mobile POS terminal associated with the transaction may be located using a wireless sensor network, i.e., the mobile POS terminal has an associated wireless sensor, such that one or more video cameras are predetermined to have a view of the mobile POS terminal location captures an image of the customer proximate the mobile POS terminal or interacting with the employee operating the POS terminal. If several people are captured in one image, the customer associated with the transaction may be determined to be the person standing closest to the employee operating the mobile POS terminal. The image(s) may be captured at the initiation, during and/or after the transaction based at least in part on messaging between the mobile POS terminal and computing apparatus 18, e.g., the mobile POS terminal signals to the computing apparatus 18 that a transaction has been initiated and/or finalized. Alternatively or in addition to capturing an image with one or more store video cameras, an image of the customer may be captured by a digital camera built-in or associated with the mobile POS terminal performing the transaction in which the image is sent to computing apparatus 18.

After the image of the customer associated with the transaction has been captured, processor 70 determines whether the customer associated with the transaction is exiting the store, i.e., whether customer 21 is proximate a predefined zone such as an EAS interrogation zone and is walking towards exit 22 (Block S130). For example, processor 70 uses video images captured from one or more video cameras located proximate exit 22 to determine whether the customer is proximate the EAS interrogation zone. In another example, processor 70 may track the customer throughout the building or retail store using one or more in-store video cameras such that processor 70 is able to determine whether the customer is proximate the EAS interrogation zone and walking towards exit 22. For example, processor 70 performs video analysis to generate a path of the customer from a transaction location to a predetermined location different from the transaction location such as a location of identification device 14 or exit 22.

If the determination is made the customer associated with the transaction is not exiting or not proximate the EAS interrogation zone, the determination of Block S130 is repeated. If the determination is made the customer associated with the transaction is exiting, processor 70 determines whether video analytics criteria 81 is met (Block S131). Video analytics criteria 81 may include one or more rules for determining whether to grant authorization to inhibit EAS system alarming. One rule in video analytics criteria 81 may include determining whether the customer or user associated with the transaction interacted with merchandise along the path trace of the customer. The path trace of the customer may indicate the customer stopped and picked up an item after the transaction but before reaching identification device 14 such that authorization may not be granted to inhibit EAS system alarming. If the path trace of the customer indicates the customer did not have interaction with merchandise along the path trace of the customer, EAS system alarming may be inhibited. The parameters for determining whether an interaction took place along the path trace may be predefined by a system provider, management employee and/or user with authorization to set the parameters. The parameters may include an amount of time the customer is stopped and/or body, e.g., arm, movement by the customer, among other parameters that may be tracked by one or more cameras that indicate the customer is interacting with un-purchased items.

If the determination is made that video analytics criteria 81 is met, processor 70 causes transmitter 66 to transmit an authorization message indicating permission to inhibit EAS system alarming has been granted (Block S132). For example, one or more authorization messages are transmitted to detection device 16, identification device 14 and/or portable device 12 using one or more communication protocols. In other words, the determination whether to inhibit EAS system alarming is made without regard to whether an active EAS tag 20 is detected. If processor 70 determines the video analytics, processor 70 causes transmitter 66 to transmit an authorization message indicating permission to inhibit EAS system alarming has not been granted (Block S133). Returning to Block S132, after the authorization message indicating permission has been granted is transmitted, processor 70 monitors the EAS interrogation zone for suspicious behavior as discussed in detail with respect to FIG. 6, e.g., determine whether warning criteria 80 are met (Block S134). Alternatively, Block S134 may be omitted based on design need.

An exemplary monitoring process is described with respect to FIG. 6. Processor 70 determines whether warning criteria 80 have been met (Block S136). Warning criteria 80 correspond to one or more predefined rules that indicate suspicious behavior when met. For example, warning criteria 80 may include a rule indicating suspicious behavior when one or more people by the proximity detector 46 while EAS system alarming is inhibited. Another rule may include determining suspicious behavior when RFID reader or capture element 44 captures other identification data associated with a priority item, i.e., priority items such as expensive electronics may also require security tag removal.

Another rule in warning criteria 80 may include determining whether the path trace of a customer associated with the transaction indicates the customer interacted with merchandise along the path trace and/or whether the path taken by the customer is suspicious. For example, the customer associated with the transaction may be given a wireless sensor node based tag or token that the customer will eventually dropped off near identification device 14 or exit 22. The path trace created by the wireless sensor node based tag that is being carried around by the customer is used to determine whether this path trace based rule is met. For example, the path trace created by a wireless sensor node tag may indicate the user interacted with one or more un-purchased item based at least in part on a predefined amount of time the customer was stopped along the path trace, i.e., warning criteria 80 is met.

In other example, the path trace created by the wireless sensor node may indicate the customer took an unconventional path to exit 22 such as a path where the customer visits multiple locations in the store after the transaction. Further, the path trace may be determined to be unconventional by processor 70 if the path trace indicates the customer visited a predetermined location after the transaction such as jewelry or expensive merchandise location within the store. Furthermore, the path trace generated by video analysis may be compared to the path trace generated by the wireless sensor node in which processor 70 can compare the two path traces for consistency. If one path trace substantially deviates from the other, warning criteria 80 may be met. Another rule in warning criteria 80 may include determining whether the wireless sensor node tag was dropped off at exit 22. For example, if the wireless sensor node tag that is given to the customer after a transaction is not dropped off at exit 22, as sensed by the wireless sensor network, warning criteria 80 is met. If the wireless sensor node tag is dropped off at or near exit 22 and/or identification device 14, warning criteria 80 may not be met.

If the determination is made that warning criteria 80 are not met, processor 70 determines whether a predefined time threshold has been reached (Block S138). For example, the predefined time threshold corresponds to an amount of time EAS system alarm signaling is inhibited similar to Block S114 such that processor 70 monitors the EAS interrogation zone while EAS system alarming is inhibited.

Referring back to Block S136, if the determination is made that warning criteria 80 are met, processor 70 causes transmitter 66 to transmit a warning and/or receive message to identification device 14, portable device 12 and/or detection device 16 (Block S140). For example, identification device 14 may trigger indicator 42 based at least in part on the received warning message, as discussed in Blocks S112. The warning message may trigger video monitoring of the predefined zone/area. Also, the warning message may be transmitted to an employee in order to notify the employee to monitor the predefined zone. A resume message may be transmitted to detection device 16 to cause detection device 16 to reinitiate EAS system alarming before the predefined time is reached in the case where warning criteria 80 are met.

With respect to FIG. 7, an exemplary inhibit process is described. Processor 60 determines whether an authorization message has been received (Block S142). If the determination is made that an authorization message has not been received, the determination of Block S142 is repeated. If processor 60 determines the authorization message has been received, processor 60 determines whether to inhibit EAS system alarming based at least in part on the authorization message (Block S144). For example, the authorization message indicates whether permission to inhibit EAS system alarming has been granted such that detection device 16 inhibits EAS system alarming when permission has been granted. EAS system alarming remains uninhibited or active when the authorization message indicates permission has not been granted.

If processor 60 determines not to inhibit EAS system alarming based at least in part on the received authorization message, processor 60 repeats the determination of Block S142. If the determination is made to inhibit EAS system alarming based at least in part on the received authorization message, processor 60 inhibits EAS system alarming (Block S146). For example, EAS system alarming may be inhibited by deactivating or disabling EAS detector 58 such that an active EAS security tag is not detected when located within EAS interrogation zone. In another example, the EAS alarm may be inhibited by disabling the EAS alarm while EAS detector 58 continues to detect active EAS security tags in the EAS interrogation zone, i.e., system 10 does not trigger a visual and/or audible alarm in response to detecting an active EAS security tag 24. Alternatively, inhibiting EAS system alarming may include altering the EAS alarm, i.e., making EAS alarming only visual, a short less obtrusive audio signal or a text message to the customer and/or employee. Inhibiting the alarm may also include switching off the power to the audio and/or light flashing sub-circuits of the alarm. This would also be accompanied by the generation of a suppression flag in the firmware or software code running on processor 60 such that no silent alarms or alarm log events would be created and sent to external servers or applications running on a local network or remote network.

After EAS system alarming has been inhibited, processor 60 determines whether a predefined time has been reached, i.e., EAS system alarming is inhibited for up to the predefined time (Block S146). The predefined time is also described with respect to Block S114 and may be defined by a management employee or other authorized person. If processor 60 determines the predefined time has not been reached, processor 60 determines whether a resume message has been received (Block S150). A resume message indicates to detection device 16 to reinitiate EAS system alarming, i.e., EAS system alarming may be reinitiated before the predetermined time is reached when warning criteria 80 are met as discussed in detail with respect to Block S140. If the determination is made a resume message has not been received, processor 60 repeats the determination of Block S148.

If the determination is made a resume message has been received, processor 60 enables or actives previously disabled EAS system alarming (Block S152). For example, processor 60 enables the previously disabled EAS detector 58. Referring back to Block S148, if the determination made the predefined time has been reached, processor 60 enables previously disabled EAS system alarming such that EAS system alarming is temporarily inhibited long enough for customer 21 to reach exit 22 without triggering an EAS alarm, i.e., performs Block S152.

An exemplary deactivation code process is illustrated in FIG. 8. Processor 30 determines whether a deactivation request has been received, i.e., whether a request has been made to inhibit EAS system alarming (Block S154). For example, portable device 12 may have a program application stored in memory 32 that prompts the user of portable device 12 to initiate a deactivation request when proximate exit 22. The deactivation request may be made by the user via an input element on portable device 12. The input element may be a button, keypad and/or touch-screen button on a mobile device, among other input elements capable of receiving an input command from the user of portable device 12. If the determination is made that deactivation has not been requested, processor 30 repeats the determination of Block S154.

If processor 30 determines deactivation has been requested, processor 30 determines whether transaction criteria are met (Block S156). The transaction criteria stored in memory 32 includes one or more rules that must be met in order for the program application to generate a deactivation code. For example, one rule in transaction criteria may include whether an electronic receipt for a transaction has been received by portable device 12. Another rule may include whether the deactivation request occurred within a predefined time period from the time the transaction occurred in which the received electronic receipt indicates when the transaction occurred. Another rule may include whether the items listed in the received electronic receipt includes at least one item associated with a security tag. In other words, portable device 12 receives completed transaction data such as via an electronic receipt such that processor 30 determines whether the transaction criteria are met. If the transaction criteria are determined not to be met, the deactivation process may end or the user may be prompted to reinitiate the deactivation code process. If the transaction criteria are met, processor 30 generates a deactivation code (Block S158). For example, processor 30 may generate a quick response (“QR”) code or other optically scanable code that indicates permission to inhibit EAS system alarming has been granted. Alternatively, processor 30 may generate an alpha, numeric or alpha-numeric code that may be input via an input element on detection device 16 such as a keypad. In other words, the generation of the deactivation code to inhibit EAS system alarming is made without regard to whether an active EAS tag is detected. After the deactivation code has been generated, portable device may display the generated code via portable device 12 display such as a mobile device display. The displayed code may be captured by capture element 44 (Block S158).

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. An apparatus for inhibiting electronic article surveillance, EAS, system alarming, the apparatus comprising:
a receiver, the receiver configured to receive captured identification data after a transaction;
a processor, the processor configured to:
determine whether the captured identification data is associated with the transaction; and
determine whether to inhibit EAS system alarming based at least in part on the determination whether the captured identification data is associated with the transaction, the determination whether to inhibit EAS system alarming being made without regard to whether an active EAS tag is detected;
a transmitter, the transmitter configured to transmit an authorization message, the authorization message indicating whether to inhibit EAS system alarming.

2. The apparatus of claim 1, wherein the determination whether to inhibit EAS system alarming is based at least in part on whether the identification data was received within a predefined time period after the transaction occurred.

3. The apparatus of claim 1, wherein the captured identification data is associated with one of a consumer and security tag, the identification data including one of a device identifier, radio frequency tag identifier and biometric data.

4. The apparatus of claim 1, wherein EAS system alarming is inhibited for a predefined amount of time when the determination is made the captured identification data is associated with the transaction, the inhibiting of the EAS system alarming includes one of inhibiting an EAS alarm and EAS tag detection, the EAS alarm indicating an active EAS tag is detected.

5. The apparatus of claim 1, wherein the receiver is further configured to receive proximity data, the proximity data indicating whether a plurality of people are detected within a predetermined area; and
the determination whether to inhibit EAS system alarming being based at least in part on the proximity data.

6. The apparatus of claim 5, wherein the transmitter is further configured to transmit a warning message when the proximity data indicates a plurality of people are detected in the predetermined area, the warning message configured to one of trigger video monitoring of the predetermined area and notify an employee to monitor the predetermined area.

7. The apparatus of claim 1, wherein the processor is further configured to generate a path trace of a customer associated with the transaction, the path trace indicating a path traveled by the customer from a transaction location to a predetermined location different from the transaction location; and
the determination whether to inhibit EAS system alarming being based at least in part on the path trace.

8. The apparatus of claim 1, wherein the captured identification data is an image of a consumer; and
the determination whether the captured identification data is associated with the transaction includes determining whether the consumer interacted with an employee operating a point of sale terminal associated with the transaction during the transaction.

9. The apparatus of claim 1, wherein the determination whether to inhibit EAS system alarming is based at least in part on a number of times the identification data has been captured.

10. A system for inhibiting electronic article surveillance, EAS, alarming, the system comprising:
an identification device, the identification device including a capture element configured to capture identification data after a transaction;
an apparatus in communication with the identification device, the apparatus including:
a processor, the processor configured to determine whether to inhibit EAS alarming based at least in part on whether the captured identification data is associated with the transaction, the determination whether to inhibit EAS alarming being made without regard to whether an active EAS tag is detected;
a transmitter, the transmitter configured to transmit an authorization message, the authorization message indicating whether to inhibit EAS alarming.

11. The system of claim 10, wherein the determination whether to inhibit EAS alarming is based at least in part on whether the identification data was received within a predefined time period after the transaction occurred.

12. The system of claim 11, wherein the captured identification data is associated with one of a consumer and security tag, the identifier including one of a device identifier, radio frequency tag identifier, biometric data.

13. The system of claim 10, wherein EAS system alarming is inhibited for a predetermined amount of time when the determination is made the captured identification data is associated with the transaction, the inhibiting of the EAS system alarming includes one of inhibiting an EAS alarm and EAS tag detection, the EAS alarm indicating an active EAS tag is detected.

14. A method for inhibiting electronic article surveillance, EAS, system alarming, the comprising:
receiving captured identification data after a transaction;
determining whether the captured identification data is associated with the transaction; and
determining whether to inhibit EAS system alarming based at least in part on the determination whether the captured identification data is associated with the transaction, the determination whether to inhibit EAS system alarming being made without regard to whether an active EAS tag is detected.

15. The method of claim 14, further comprising transmitting an authorization message, the authorization message indicating whether to inhibit EAS system alarming.

16. The method of claim 14, wherein the captured identification data is an image of a consumer; and
the determination whether the captured identification data is associated with the transaction includes determining whether the consumer was proximate a point of sale terminal associated with the transaction during the transaction.

17. The method of claim 14, wherein the captured identification data is an image of a consumer; and
the determination whether the captured identification data is associated with the transaction includes determining whether the consumer interacted with an employee operating a point of sale terminal associated with the transaction during the transaction.

18. The method of claim 14, wherein the determination whether to inhibit EAS system alarming is based at least in part on whether the identification data was received within a predefined time period after the transaction occurred.

19. The method of claim 14, wherein EAS system alarming is inhibited for a predetermined amount of time when the determination is made the captured identification data is associated with the transaction, the inhibited EAS system alarming includes one of inhibiting an EAS alarm and EAS tag detection, the EAS alarm indicating an active EAS tag is detected.

20. The method of claim 14, further comprising:
generating a path trace of a customer associated with the transaction, the path trace indicating a path traveled by the customer from a transaction location to a predetermined location different from the transaction location; and
the determination whether to inhibit EAS system alarming being based at least in part on the path trace.

21. The method of claim 14, wherein the receiver is further configured to receive proximity data, the proximity data indicating whether a plurality of people are detected within a predetermined area; and
the determination whether to inhibit EAS system alarming being based at least in part on the proximity data.
